(19) United States
(12) Patent Application Publication
(10) Pub. No.: US 2010/0070374 A1
(43) Pub. Date: Mar. 18, 2010

(54) METHOD FOR SUPPLY AND DEMAND PRICING WITHIN A CONSUMER ESTABLISHMENT

(76) Inventor: Michael Carter, Moorestown, NJ (US)

Correspondence Address: CONNOLLY BOVE LODGE & HUTZ, LLP, P O BOX 2207, WILMINGTON, DE, 19899, US

(21) Appl. No.: 12/559,852

(22) Filed: Sep. 15, 2009

Related U.S. Application Data
(60) Provisional application No. 61/096,906, filed on Sep. 15, 2008.

(51) Int. Cl. G06Q 10/00; G06Q 50/00; G06Q 30/00

(52) U.S. Cl. 705/15; 705/400; 705/28; 705/22

(57) ABSTRACT

A method for pricing menu items at a consumer establishment includes repeatedly receiving data with a tracking system, where the data relates to at least one of menu item supplies and patron orders for menu items available at the consumer establishment. The received data is repeatedly analyzed, and the analyzed data is used to set current prices for the menu items. The current prices are then displayed to a patron, and an order is received from the patron for one or more of the menu items based upon the current prices.

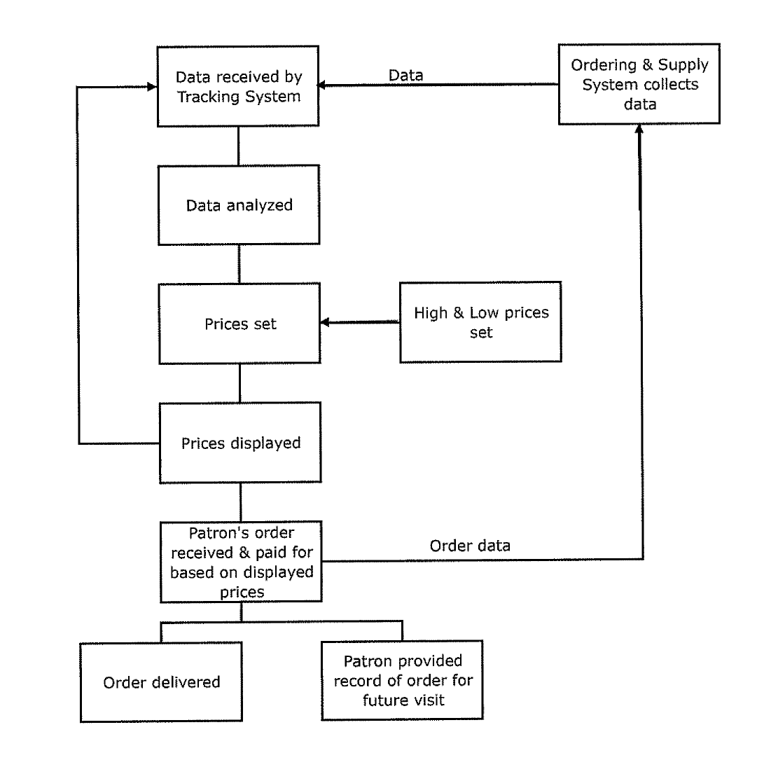

### PRIORITY

Priority is claimed to U.S. Provisional Patent Application No. 61/096,906, filed Sep. 15, 2008, the disclosure of which is incorporated herein by reference in its entirety.

### BACKGROUND OF THE INVENTION

1. Field of the Invention

The field of the invention is consumable services, and particularly menu pricing at dining and/or drinking establishments.

2. Background

Restaurants, bars, and other consumer establishments where food and/or drink is prepared and served to patrons generally have pre-printed menus showing fixed prices. In some instances, the pre-printed menus are used for months or years before any changes are made to the menu or pricing of the menu items. In other instances, the menus are printed on a daily basis, often to reflect daily menu changes. However, even in such instances where the menu is printed daily, the pricing of the items on the menu remains static. Some consumer establishments place items on the menu, such as the seafood catch of the day or seasonal items, which are listed for sale at the going “market price”. However, during any given day of operation, even market prices generally remain static. Moreover, the only way for the patron to find out the current market prices is the ask the wait staff.

### SUMMARY OF THE INVENTION

The present invention is directed toward a method for pricing menu items at a consumer establishment. Data is repeatedly received with a tracking system, where the data relates to at least one of menu item supplies and patron orders for menu items available at the consumer establishment. The received data is repeatedly analyzed, and the analyzed data is used to set current prices for the menu items. The current prices are then displayed to a patron, and an order is received from the patron for one or more of the menu items based upon the current prices.

Accordingly, an improved method for pricing menu items at a consumer establishment is disclosed. Advantages of the improvements will appear from the drawings and the description of the preferred embodiment.

### BRIEF DESCRIPTION OF THE DRAWING

The FIGURE is a flow chart illustrating a method for pricing menu items at a consumer establishment.

### DETAILED DESCRIPTION OF THE PREFERRED EMBODIMENT

Turning in detail the drawing, the flow chart illustrates a method for pricing menu items at a consumer establishment, such as a restaurant or bar. “Menu items”, as used herein, may include any prepared or pre-packaged food item that is provided to the patron at the consumer establishment, or any pre-packaged, prepared or mixed drink, including alcoholic drinks, which are also provided to the patron at the consumer establishment.

The data used by the tracking system is collected by an ordering and supply system of the type that is commonly used in both restaurants and bars for tracking consumables and patrons' orders. The ordering and supply system may be of any type known to those skilled in the art. Such tracking systems generally track all orders placed for menu items, and all supplies, including the primary ingredients for culinary preparations, pre-made food items, ingredients for mixed beverages, pre-made beverages (cola, beer, etc.) and the like. Of course, the beverages may be alcoholic and/or non-alcoholic, depending upon the menu choices made by the consumer establishment. In addition, it is possible to have the tracking system and the ordering and supply system fully integrated with each other into a single, monolithic system. Data from the ordering and supply system is received by the tracking system, where it is analyzed. The method of transferring the data may take almost any known form for transferring data between the two systems, such as a wired or wireless network, or even via a portable data storage device such as an optical disk or a nonvolatile random access memory token. However, if data is transferred using a method that does not permit on-demand communications between the two systems, real time menu pricing will be unavailable. In such cases, the pricing will have an inherent delay as compared to the time of data collection by the ordering and supply system.

Once the data is received by the tracking system, that data is analyzed and menu prices are set based upon the data analysis. The data analysis may be any appropriate or desired form of analysis, including anything from complex statistical analyses to a simplified analysis which looks for predetermined thresholds within the supply and demand data.

In setting the prices for the menu items, the tracking system may again use any number of known or desired methods for setting prices. Here, the real limits are based upon the needs of the consumer establishment. For example, the operator of the consumer establishment may wish to individually set absolute high and low prices for some or all of the various menu items to place limits on the pricing capabilities of the tracking system. By setting the high and low prices for different menu items, the operator can ensure that menu item prices do not sink below the cost of supplies, and on the flipside, the menu item prices do not increase so drastically as to offend consumer sensibility.

In addition to analyzing the supply and order data and setting prices, the tracking system may also track the pricing history for the various menu items. Other history data which may be tracked includes the different menu items that are ordered and the price associated with each individual order, the numbers of previously ordered menu items which have been and have yet to be delivered, the cost of supplies used to prepare the various menu items, and any other parameter associated with the business of being a consumer establishment serving food and/or drinks. Some of the tracked parameters might include supply pricing, menu item pricing, supplies on hand, future orders, whether they are orders by patrons for future delivery of menu items or orders by the consumer establishment for additional supplies, anticipated dates by which the supplies are no longer considered suitable for use in preparing the menu items, and the like.

Returning to the FIGURE, once the prices are set, the menu item prices are displayed to the patrons of the consumer establishment. The display may take any form, but is preferably an electronic display that may be updated in real-time, with current prices determined by the data analysis, by the tracking system. Thus, the patrons of the consumer establishment will always see menu item prices based on the most currently available supply and demand data for the consumer establishment. The display may also show pricing trends for the various menu items, such as whether over the last hour the price has gone up or down, and by how much. The operator of the consumer establishment has complete control and discretion over what time intervals to use when displaying trend data. In addition, the operator of the consumer establishment may choose to set different time intervals for different menu items.

The display of the menu item prices may take any form, from a simple ticker board, such as the type often used to display stock market information, to a graphic overlay on a video monitor, to a graphic sidebar on a video monitor. The latter two would allow patrons of the consumer establishment to continue watching available video programming while at the same time seeing all the current menu prices on the same monitor. Where the graphic overlay might cover part of the video programming, the sidebar would make it so the menu item pricing display does not overlap or intrude upon the video programming.

With menus in hand and menu item pricing on display, patrons may place orders for desired menu items at the most current prices. With this type of system, payment should be expected at the time the order is placed, or at least before the patron leaves the consumer establishment on the day the order is placed. However, any type of desirable payment plan may be established by the operator of the consumer establishment. Once an order from a patron is received, it is entered into the ordering and supply system so that the data may be collected and then transferred back into the tracking system. Patrons may be given the option of having their order delivered immediately upon preparation, or placing an order for menu items that will be delivered at some specified time in the future, such as a visit to the consumer establishment at a later date. Patrons may also be given the option of ordering as many menu items as they choose at the then current prices for delivery at a later time. The later time may be at any time the consumer establishment and patron choose to agree upon. For example, the later time may specified at the time the order is placed, or the patron may be given a record, such as a print out, or given an identifier, such as a patrons' identification card, which indicates or enables the tracking system to keep track of how many of which menu items were ordered, by which patron, and the date the order was placed. The tracking system would then keep a record of the ordered items and keep track of delivery of any of those ordered items as delivery occurs. In this manner, patrons can purchase menu items when they see the price for those menu items at or near a low, and return at a later date for delivery of those menu items, regardless of what the prices at that later date.

In addition, the above system may be implemented for more than a single consumer establishment, where the consumer establishments are tied together in some manner, such that the data from the ordering and supply systems for each consumer establishment is directed into a single tracking system. The single tracking system is then used to analyze the combined data and set menu item prices for both establishments. In such a case, it may be desirable to enable the tracking system to set different menu item prices for each establishment to take into account localized trends within each establishment.

Thus, a method for pricing menu items at a consumer establishment is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method for pricing menu items at a consumer establishment, the method comprising:
repeatedly receiving data with a tracking system, the data relating to at least one of menu item supplies and patron orders for menu items available at the consumer establishment;
repeatedly analyzing the received data, the analyzed data being used to set current prices for the menu items;
displaying the current prices for the menu items to patrons; and
receiving an order from a patron for one or more of the menu items based on the current prices.

2. The method of claim 1, further comprising setting high and low prices for each menu item within the tracking system.

3. The method of claim 2, wherein the high and low prices are set by an operator of the consumer establishment.

4. The method of claim 2, wherein the current price for each menu item is set between the high and low price for that menu item.

5. The method of claim 1, further comprising receiving payment from the patron at the current price based on when the order is placed.

6. The method of claim 5, wherein the received order is for delivery of the ordered menu item during a subsequent visit to the consumer establishment.

7. The method of claim 6, further comprising providing the patron a record of ordered menu items to be delivered during a subsequent visit to the consumer establishment.

8. The method of claim 6, wherein the subsequent visit to the consumer establishment is determined by the patron.

9. The method of claim 6, wherein the subsequent visit to the consumer establishment is determined at the time of receiving the order for the menu item.

10. The method of claim 1, wherein the data concerning menu item supplies comprises supplies of ingredients for menu items.

11. The method of claim 10, wherein the menu items include beverages.

12. The method of claim 10, wherein the beverages comprise alcoholic beverages.

13. The method of claim 10, wherein the menu items include culinary preparations.

14. The method of claim 1, further comprising interfacing the tracking system with a supplies and/or ordering system of the consumer establishment to enable transfer of the data from the supplies and/or ordering system to the tracking system.

15. The method of claim 1, wherein displaying the current prices includes displaying pricing trends for menu items.

16. The method of claim 1, wherein displaying the current prices includes displaying the current prices on a ticker display.

17. The method of claim 16, wherein the ticker display is one of a partial overlay or a sidebar on a video monitor.

18. The method of claim 1, wherein the data relating to patron orders for menu items includes ordering trends for menu items.

19. The method of claim 1, wherein the received data relates to menu item supplies and patron orders for menu items from at least two co-managed consumer establishments.
